(19) United States
(12) Patent Application Publication
(10) Pub. No.: US 2003/0104823 A1
(43) Pub. Date: Jun. 5, 2003

(54) Portable telephone terminal with position-determining function

(75) Inventor: Hiroshi Ono, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/303,914

(22) Filed: Nov. 26, 2002

(30) Foreign Application Priority Data
Nov. 30, 2001 (JP) 2001-367312

(51) Int. Cl. H04Q 7/20; H04B 7/005

(52) U.S. Cl. 455/456; 455/502

(57) ABSTRACT

A portable telephone terminal supplies a high-accuracy clock signal during the position determination operation and makes it possible to conduct synchronized introduction of a clock signal into the terminal at an appropriate time. A first radio section transmits and receives a telephone signal. A second radio section receives a position determination signal from a satellite. A clock synchronizer synchronizes a clock signal for the second radio section with a clock signal for the first radio section based on a frequency obtained from the first radio section prior to start of a position determination operation. A controller may be additionally provided for controlling the operations of the first and second radio sections. The controller conducts its operation in such a way as to connect the terminal to a radio line prior to a position determination operation. The clock synchronizer conducts its synchronization operation after the terminal is connected to the radio line.

### BACKGROUND OF THE INVENTION

1. Field of the Invention

The present invention relates generally to a portable telephone terminal. More particularly, the invention relates to a portable telephone terminal having a position-determining function, such as a function to determine the terminal's position on the earth using the Global Positioning System (GPS) or the like.

2. Description of the Related Art

Several methods of measuring or determining the present position (i.e., position determination methods) of an object or target have ever been known well. Some examples of them are the method using the GPS, the method using the cell number of the portable telephone system, and the method using the time of arrival of the received or transmitted signal of the portable telephone system. In these known methods, the position determination method using the GPS includes three types, the “independent” type, the “server-assisted” type, and the “server-driven” type.

With the “independent” type position determination method, a GPS terminal having a built-in GPS receiver is used. The receiver in the GPS terminal receives the position information transmitted from GPS satellites. All necessary calculations for determining the position of the terminal using the information thus received are conducted in the GPS terminal itself, thereby determining the terminal's position.

With the “server-assisted” type position determination method, a GPS reference receiver for receiving the information transmitted from GPS satellites, and a computer termed a GPS server are used. The GPS reference receiver is connected to the GPS server. The GPS server is connected to a computer network (typically, the Internet). The GPS reference receiver receives the information transmitted from GPS satellites and transmits the same to the GPS server. A GPS terminal accesses the GPS server by way of the computer network to obtain the information transmitted from the GPS satellites. Thereafter, the GPS terminal makes all necessary calculations for determining the position of the said terminal in the terminal itself using the information thus obtained, thereby determining the terminal's position.

With the “server-driven” type position determination method, a computer termed a GPS server is used. The GPS server is connected to a computer network (typically, the Internet). A GPS terminal having a built-in GPS receiver receives the information transmitted from GPS satellites and then, transmits the same to the GPS server by way of the computer network. Thereafter, the GPS server makes necessary calculations for determining the position of the said GPS terminal using the information thus received. The GPS terminal accesses the GPS server by way of the computer network to obtain the result of the calculations, thereby determining the terminal's position.

FIG. 1 is a schematic illustration showing a prior-art position determination method using a portable telephone terminal having a position-determining function (i.e., having a built-in GPS receiver). This method, which is realized by using a portable telephone system and a GPS, is of the “server-driven” type.

With the prior-art method shown in FIG. 1, a portable telephone network 102, a Public Switched Telephone Network (PSTN) 104, and the Internet 106 are used. The network 102, the PSTN 104, and the Internet 106 are connected to each other by radio or wire and thus, they are communicable mutually. GPS satellites 108a, 108b, and 108c are placed in orbit around the earth.

Portable telephone terminals 101 and 103 are connected to the portable telephone network 102. An ordinary telephone terminal 105 is connected to the PSTN 104. A computer 107 termed a “server” and a computer 110 termed a “GPS server” are connected to the Internet 106. A GPS reference receiver 109 is connected to the GPS server 110.

The portable telephone terminal 101 comprises a GPS receiver section 101a for GPS communication along with a radio communication section 101b for telephone conversation or communication. Therefore, with the terminal 101, not only conversation and data communication can be conducted with the radio communication section 101b but also reception of the information transmitted from the GPS satellites 108a to 108c can be conducted with the GPS receiver section 101a, as the occasion demands.

The GPS reference receiver 109 and the GPS server 110 are mounted in a base station of the portable telephone network 102. The receiver 109 constantly receives the GPS signals to recognize the present position of the base station or the receiver 109 itself.

When the portable telephone terminal 101 is connected to the portable telephone network 102 by radio, the terminal 101 is capable of audio communication or data communication with the portable telephone terminal 103 connected by radio to the network 102, the telephone terminal 105 connected to the network 102 by way of the PSTN 104, and/or the server 107 connected to the network 102 by way of the Internet 106.

The GPS satellites 108a, 108b, and 108c, which go constantly around the surface of the earth, transmit radio waves containing specific information toward the earth. The portable telephone terminal 101 having the GPS function can receive the radio waves thus transmitted. By receiving the radio waves thus transmitted, the user of the terminal 101 can know the accurate present position of the terminal 101 and the accurate present time thereof. A clock signal for the terminal 101 can be obtained from the radio waves as well.

As described above, the prior-art position determination method shown in FIG. 1 is of the “server-driven” type. Therefore, when the portable telephone terminal 101 with the GPS function receives the radio waves transmitted from the satellites 108a, 109b, and 108c, almost all the necessary calculations for finding or determining the current position of the terminal 101 are carried out in the terminal 101 itself based on the information obtained from the waves received. On the other hand, the remaining part of the calculations is carried out in the GPS server 110. Thus, the necessary information is sent from the terminal 101 to the GPS server 110 by way of the portable telephone network 102 and the Internet 106. After all the necessary calculations are completed, the calculation result is sent back to the terminal 101 from the server 110 in a similar way. As a result, the user of the terminal 101 can know his/her present position easily as necessary.

FIG. 2 shows an example of the circuit configuration of the portable telephone terminal 101 with the GPS function.

In FIG. 2, a GPS antenna 111 receives the GPS signals sent from the satellites 10a, 108b, and 108c in the form of radio waves. A GPS radio section 112 demodulates the GPS signals thus received by the antenna 111. A GPS decoder section 113 decodes the GPS signals thus demodulated. A transmitting/receiving antenna 114 transmits or receives radio signals for portable telephone. These elements and sections are incorporated with each other to form a GPS terminal unit.

A portable telephone radio section 115 modulates and demodulates the radio signals for portable telephone. A system processor section 116 processes the portable telephone signals and the GPS signals. An audio input/output section 118 is used for the user to input his/her voice into the terminal 101 and to output the voice of a person the user communicates from the terminal 101. An audio processor section 119 processes the audio or voice information that passes through the section 118. A display 120 displays necessary information on the screen (not shown) to notify it to the user. A display processor section 121 processes the information to be displayed on the screen of the display 120. A CPU (Central Processing Unit) 122 controls the whole operation of the terminal 101.

FIG. 3 shows an example of the GPS position determination operation of the “server-driven” type conducted in the prior-art terminal 101 shown in FIG. 1. The steps D27 to D32 represent the operation flows for line connection. The steps D33 to D37 represent the operation flows for position determination of the terminal 101, which are realized under cooperation of the terminal 101 and the GPS server 110.

First, the CPU 122 in the terminal 101 makes a call request to the call control layer provided in the system processor section 116 of the terminal 101 (step D27). In response, the said call control layer conducts a call-out process to the radio line control layer in the terminal 101 (step D28). Thus, the said radio line control layer conducts the line connection process to the radio line control layer provided in a base station in the portable telephone network 102 (step D29). In response, the said radio line control layer in the base station conducts the call-in notification to the call control layer in the same base station (step D31) and at the same time, conducts the line connection reply to the said radio line control layer in the terminal 101 (step D30). Responsive to this line connection reply, the said call control layer in the terminal 101 receives the call completion notification from the said radio line control layer in the said base station (step D32). In this way, the line connection between the terminal 101 and the GPS server 110 is completed. Thus, an upper layer data path is opened or formed between the terminal 101 and the server 110 (step D33).

Subsequently, to conduct position determination (i.e., measuring of the current position) of the terminal 101 with the GPS function while keeping the line connection between the terminal 101 and the GPS server 110, the CPU 122 makes a request for position determination to the GPS decoder section 113 by way or the system processor section 116 in the terminal 101 (step D34). In response, the GPS radio section 112 demodulates the GPS signals that have been sent from the GPS satellites 108a, 108b, 108c and received by the GPS antennal 111 and then, the GPS decoder section 113 decodes the signals thus demodulated (step D35). After the decoding processes are completed, the decoder section 113 makes a notification of completion of the position determination operation to the CPU 122 by way of the system processor section 116 (step D36). In response, necessary position data transmission (i.e., transmission of data/information relating to the position) is carried out between the CPU 122 in the terminal 101 and the upper layer in the GPS server 110 (step D37). For example, the CPU 122 sends the GPS information thus demodulated and decoded to the GPS server 110 by way of the upper layer data path formed in the step D33.

With the above-described prior-art portable telephone terminal 101, as seen from the circuit configuration of FIG. 2, the portable telephone radio section 115 and the GPS radio section 112 operate separately and independently. Thus, there is a first problem that a high-accuracy frequency oscillator or the like is required for each of the radio sections 112 and 115 to generate its own clock signal.

Moreover, high-precision frequency compensation by the portable telephone radio section 115 is possible only when the lines are connected between the portable telephone terminal 101 and the portable telephone network 102. High-precision frequency compensation is not possible when the lines are disconnected between the terminal 101 and the network 102. Also, it is difficult to generate a high-precision frequency in the state where the lines are disconnected between the terminal 101 and the network 102, if the method is not of “server-driven” type. These are a second problem.

Furthermore, since the GPS position determination section (i.e., the GPS terminal unit) operates separately from the portable telephone section, the position determination operation is carried out independent of the state of reception of the GPS radio waves. As a result, there is a third problem that the failure of position determination is repeated or position determination with insufficient accuracy is kept being conducted.

### SUMMARY OF THE INVENTION

Accordingly, an object of the present invention is to provide a portable telephone terminal that supplies a high-accuracy clock signal during the position determination operation.

Another object of the present invention is to provide a portable telephone terminal that makes it possible to conduct synchronized introduction of a clock signal into the terminal at an appropriate time.

Still another object of the present invention is to provide a portable telephone terminal that prevents effectively position determination failure and position determination with insufficient accuracy.

A further object of the present invention is to provide a portable telephone terminal that prevents or suppresses useless power consumption due to position determination failure or position determination with insufficient accuracy.

The above objects together with others not specifically, mentioned will become clear to those skilled in the art from the following description.

According to a first aspect of the present invention, a portable telephone terminal with a position-determining function is provided. This terminal comprises:

a first radio section for transmitting and receiving a telephone signal;

a second radio section for receiving a position determination signal from a satellite; and

a clock synchronizer for synchronizing a clock signal for the second radio section with a clock signal for the first radio section based on a frequency obtained from the first radio section prior to start of a position determination operation.

With the portable telephone terminal according to the first aspect of the present invention, the clock synchronizer is provided for synchronizing a clock signal for the second radio section with a clock signal for the first radio section based on a frequency obtained from the first radio section prior to position determination operation. Therefore, a clock signal for the second radio section can be synchronized with a clock signal for the first radio section using the frequency of a telephone signal having a higher accuracy than that of a position determination signal. As a result, by deriving a frequency of the telephone signal from the first radio section while keeping the lines connected, a clock signal synchronized with the frequency thus derived can be supplied to the second radio section (i.e., can be introduced into the terminal). This means that the first and second radio sections can be operated synchronously with each other without using a high-accuracy frequency oscillator or the like.

Since the synchronization of the clock signal for the second radio section with that for the first radio section is carried out prior to the start of a position determination operation to be required, the synchronized introduction of the clock signal for the second radio section to the terminal can be conducted at an appropriate time or timing.

Moreover, the first and second radio sections are operated synchronously with each other by their high-accuracy clock signals and thus, the necessary calculations for position determination are ensured. Therefore, the position determination failure and the position determination with insufficient accuracy are prevented. Since the necessary calculations for position determination will be completed faster than the above-described prior-art portable telephone terminal, the sensitivity and speed of position determination are improved.

Further, the first and second radio sections are operated synchronously with each other. Therefore, if it is recognized from the state of line connection that the portable telephone terminal is located in an inappropriate situation for position determination, the second radio section can be controlled not to conduct its position determination operation. As a result, a phenomenon that electric power is undesirably consumed due to a useless operation for position determination is prevented. This means that the lifetime of a battery mounted on the portable telephone terminal is prevented from being reduced.

In a preferred embodiment of the terminal according to the first aspect of the invention, a controller is additionally provided for controlling the operations of the first and second radio sections. The controller conducts its operation in such a way as to connect the terminal to a radio line prior to an operation for position determination. The clock synchronizer conducts its synchronization operation after the terminal is connected to the radio line.

In another preferred embodiment of the terminal according to the first aspect of the invention, the controller makes a judgment whether the radio line is in a state of communicating, waiting, or out-of-range. According to result of the judgment, the position determination operation is conducted in different ways.

In still another preferred embodiment of the terminal according to the first aspect of the invention, the clock synchronizer comprises a frequency supplier for supplying the frequency obtained from the first radio section to the second radio section. Alternately, the clock synchronizer comprises a frequency error calculator for calculating a frequency-error by comparing the frequency obtained from the first radio section with a frequency obtained from the second radio section, and a frequency-error elimination controller for controlling a decoder for position determination in such a way as to eliminate the frequency error.

In a further preferred embodiment of the terminal according to the first aspect of the invention, the position determination operation of the controller is of an independent type. Alternately, the position determination operation of the controller is of a server-assisted type. In the latter case, the portable telephone terminal is connected to the radio line prior to start of a position determination operation. Auxiliary data required for calculation for position determination is received from a server by way of a portable telephone network. Thereafter, the position determination operation of the controller is conducted.

If the position determination operation of the controller is of a server-assisted type position determination method, preferably, the controller registers a position of the portable telephone terminal in the server by way of the portable telephone network. Thereafter, the clock synchronizer conducts its synchronization operation of the clock signal for the second radio section with the clock signal for the first radio section using a frequency corresponding to the position registered.

According to a second aspect of the present invention, another portable telephone terminal with a position-determining function is provided. This terminal comprises:

a first radio section for transmitting and receiving a telephone signal;

a second radio section for receiving a position determination signal from a satellite; and

a controller for controlling operations of the first and second radio sections;

wherein the controller conducts its control operation in such a way as to acquire cell information identifying or specifying a cell to which the portable telephone terminal belongs from outside by way of a portable telephone network;

and wherein if a desired position determination operation can be conducted based on the cell information acquired, the controller conducts its control operation in such a way as to conduct the desired position determination operation using the cell information without using the position determination signal from the satellite.

With the portable telephone terminal according to the second aspect of the present invention, the controller conducts its control operation in such a way as to acquire cell information identifying or specifying a cell to which the portable telephone terminal belongs from outside by way of a portable telephone network. Then, if a desired position determination operation can be conducted based on the cell information acquired, the controller conducts its control operation in such a way as to conduct the desired position determination operation using the cell information without using the position determination signal from the satellite. Therefore, a phenomenon that electric power is undesirably consumed due to a useless operation for position determination using the position determination signal from the satellite is prevented. This means that the lifetime of a battery mounted on the portable telephone terminal is prevented from being reduced.

In a preferred embodiment of the terminal according to the second aspect of the invention, if a desired position determination operation cannot be conducted based on the cell information acquired, the controller conducts its control operation in such a way as to conduct the desired position determination operation using the position determination signal from the satellite.

In another preferred embodiment of the terminal according to the second aspect of the invention, if a desired position determination operation cannot be conducted based on the cell information acquired, the controller conducts its control operation in such a way as to synchronize a clock signal for the second radio section with a clock signal for the first radio section based on a frequency obtained from the first radio section prior to start of the desired position determination operation using the position determination signal from the satellite. In this embodiment, the following additional advantages are obtainable.

(i) The first and second radio sections can be operated synchronously with each other without using a high-accuracy frequency oscillator or the like for clock signal generation.

(ii) Synchronized introduction of a clock signal for the second radio section into the terminal can be conducted at an appropriate time or timing.

(iii) The sensitivity and speed of position determination are improved.

According to a third aspect of the present invention, still another portable telephone terminal with a position-determining function is provided. This terminal comprises:

a first radio section for transmitting and receiving a telephone signal;

a second radio section for receiving a position determination signal from a satellite;

an analyzer for analyzing times of arrival of telephone signals obtained from the first radio section; and

a controller for controlling operations of the first and second radio sections;

wherein the analyzer analyzes times of arrival of the telephone signals obtained from the first radio section, thereby calculating their time differences of arrival;

and wherein the controller conducts its control operation in such a way as to conduct a position determination operation based on the time differences of arrival calculated.

With the portable telephone terminal according to the third aspect of the present invention, the analyzer analyzes times of arrival of telephone signals obtained from the first radio section, thereby calculating their time differences of arrival. The controller conducts its control operation in such a way as to conduct a position determination operation based on the time differences of arrival calculated. Therefore, according to the status or circumstance where the portable telephone terminal is placed, the position determination operation using the position determination signal from the satellite or the position determination operation using the time differences of arrival of the telephone signals can be selected as necessary. As a result, a phenomenon that electric power is undesirably consumed due to failure of position determination and/or position determination with insufficient accuracy is prevented. This means that the lifetime of a battery mounted on the portable telephone terminal is prevented from being reduced.

Moreover, according to circumstances, both of the position determination operation using the position determination signal from the satellite and the position determination operation using the time differences of arrival may be conducted. If so, the accuracy of position determination is improved further.

In a preferred embodiment of the terminal according to the third aspect of the invention, if the position determination operation using the time differences of arrival of the telephone signals can be conducted, the controller conducts its control operation in such a way that a position determination operation using the position determination signal from the satellite is not conducted. The controller conducts its control operation in such a way that a position determination using the position determination signal from the satellite is conducted if the position determination operation using the time differences of arrival is failed.

In another preferred embodiment of the terminal according to the third aspect of the invention, the position determination operation of the controller using the time differences of arrival is of an independent type.

Alternately, the position determination operation of the controller using the time differences of arrival is of a server-assisted type. In this case, the portable telephone terminal is connected to a radio line prior to start of the position determination operation using the time differences of arrival. The terminal receives auxiliary data required for calculation for position determination from a server by way of a portable telephone network. Thereafter, the position determination operation using the time differences of arrival is conducted.

Alternately, the position determination operation of the controller using the time differences of arrival is of a server-driven type. In this case, the portable telephone terminal is connected to a radio line prior to start of the position determination operation using the time differences of arrival. The terminal receives auxiliary data required for calculation for position determination from a server by way of a portable telephone network. Thereafter, calculations necessary for the position determination are conducted in the server.

In still another preferred embodiment of the terminal according to the third aspect of the invention, if the position determination operation of the controller using the time differences of arrival can be conducted, the controller conducts its control operation in such a way as that necessary calculations for the position determination are conducted in the server.

In a further preferred embodiment of the terminal according to the third aspect of the invention, the controller conducts its control operation in such a way as to synchronize a clock signal for the second radio section with a clock signal for the first radio section based on a frequency obtained from the first radio section prior to start of a desired position determination operation using the position determination signal from the satellite. In this embodiment, the following additional advantages are obtainable.

(i) The first and second radio sections can be operated synchronously with each other without using a high-accuracy frequency oscillator or the like for clock signal generation.

(ii) Synchronized introduction of a clock signal for the second radio section into the terminal can be conducted at an appropriate time or timing.

(iii) The sensitivity and speed of position determination are improved.

In a still further preferred embodiment of the terminal according to the third aspect of the invention, the controller conducts its control operation in such a way as to conduct a position determination operation using the position determination signal from the satellite after a position determination operation using the time differences of arrival is completed.

### BRIEF DESCRIPTION OF THE DRAWINGS

In order that the present invention may be readily carried into effect, it will now be described with reference to the accompanying drawings.

FIG. 1 is a schematic diagram showing the concept of a position determination method using a prior-art portable telephone terminal.

FIG. 2 is a schematic functional diagram showing an example of the circuit configuration of the prior-art portable telephone terminal of FIG. 1.

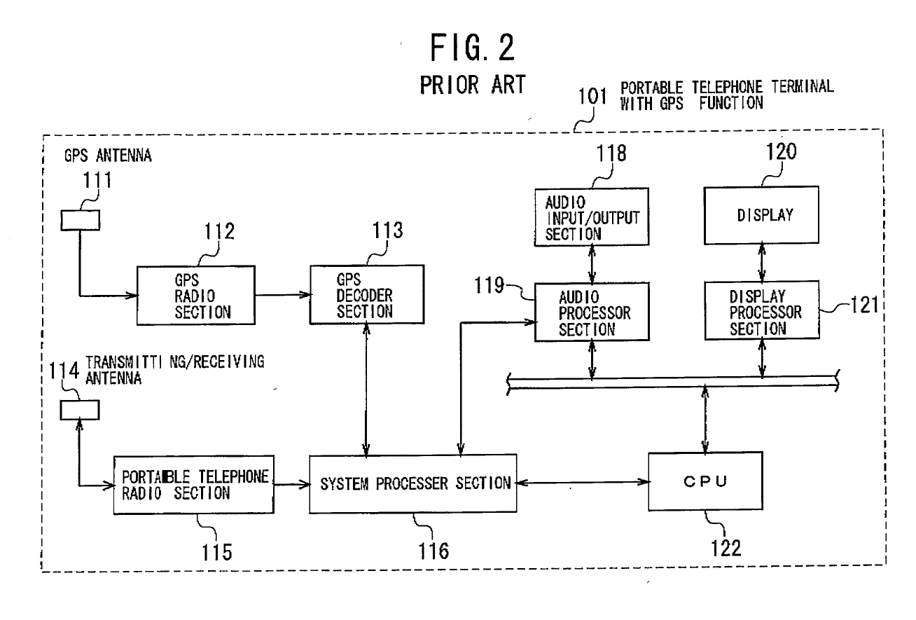

FIG. 3 is a sequence diagram showing the operation of the prior-art portable telephone terminal of FIG. 1.

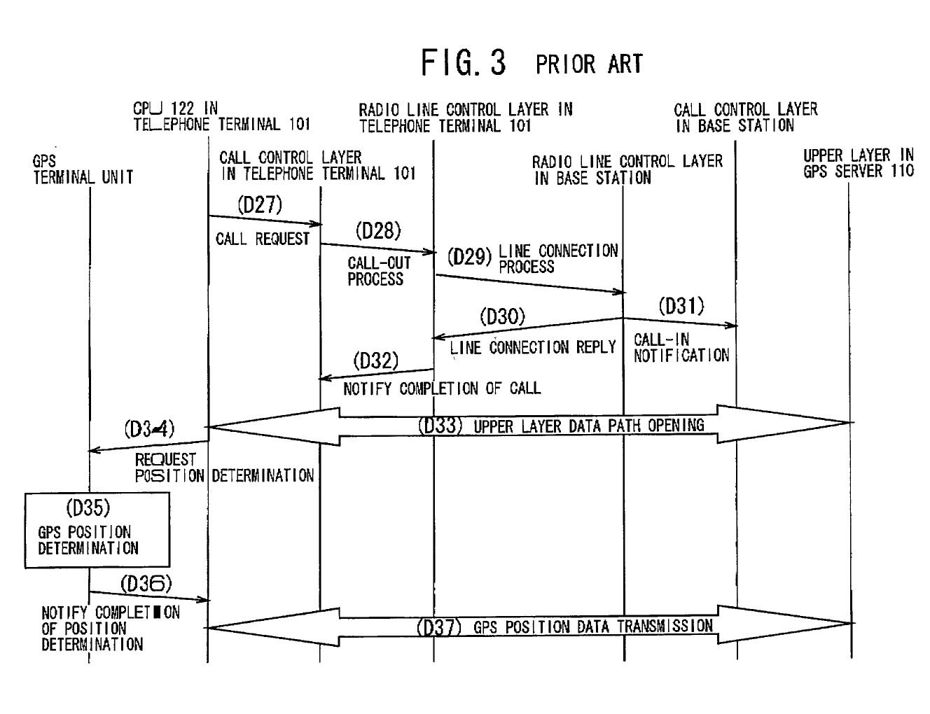

FIG. 4 is a schematic diagram showing the concept of a position determination method of using a portable telephone terminal according to a first embodiment of the invention.

FIG. 5 is a schematic functional diagram showing an example of the circuit configuration of the portable telephone terminal according to the first embodiment of FIG. 4.

FIG. 6 is a sequence diagram showing the operation of the portable telephone terminal according to the first embodiment of FIG. 4.

FIG. 7 is a flowchart showing the operation of the portable telephone terminal according to the first embodiment of FIG. 4.

FIG. 8 is a schematic functional diagram showing the circuit configuration of a portable telephone terminal according to a second embodiment of the invention.

FIG. 9 is a sequence diagram showing the operation of a portable telephone terminal according to a third embodiment of the invention.

FIG. 10 is a sequence diagram showing the operation of a portable telephone terminal according to a fourth embodiment of the invention.

FIG. 11 is a flowchart showing the operation of the portable telephone terminal according to the fourth embodiment of FIG. 10.

FIG. 12 is a schematic diagram showing the concept of a position determination method using a portable telephone terminal according to a fifth embodiment of the invention.

FIG. 13 is a schematic functional diagram showing the circuit configuration of the portable telephone terminal according to the fifth embodiment of FIG. 12.

FIG. 14 is a sequence diagram showing the operation of the portable telephone terminal according to the fifth embodiment of FIG. 12.

FIG. 15 is a flowchart showing the operation of the portable telephone terminal according to the fifth embodiment of FIG. 12.

### DETAILED DESCRIPTION OF THE PREFERRED EMBODIMENTS

Preferred embodiments of the present invention will be described in detail below while referring to the drawings attached.

### First Embodiment

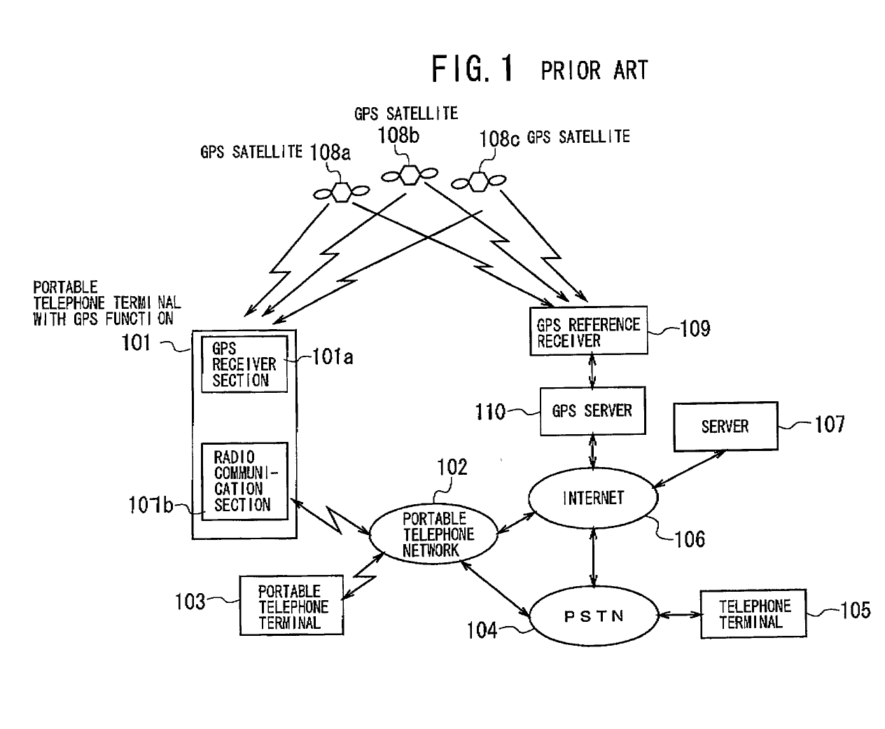

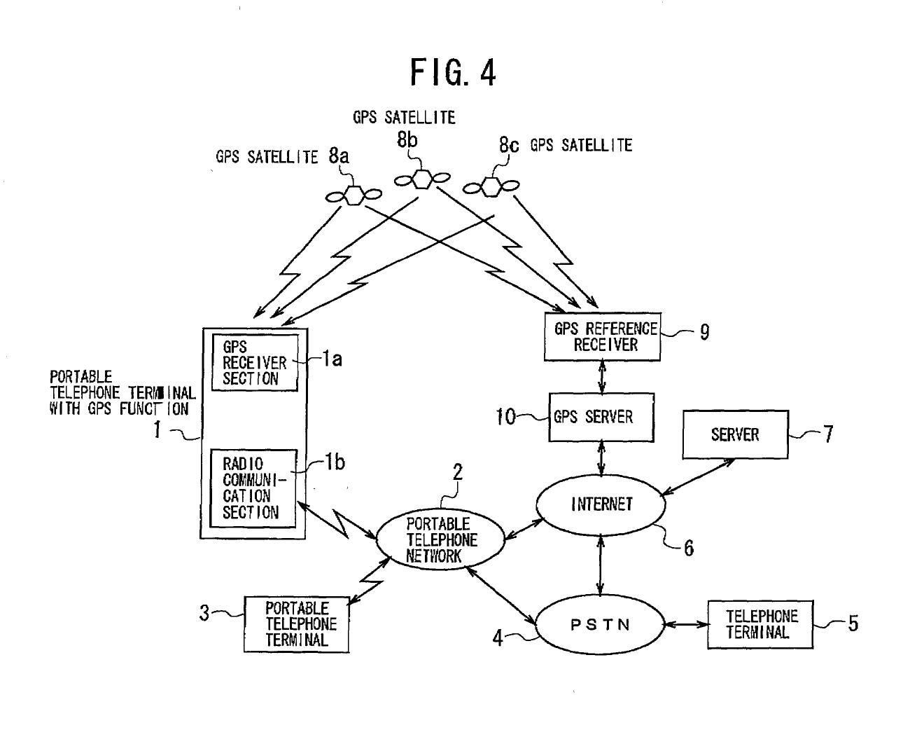

A position determination method using a portable telephone terminal having a position-determining function (i.e., having a built-in GPS receiver) is schematically shown in FIG. 4. The constituting elements in FIG. 4 are substantially the same as those in FIG. 1. This position determination method, which may be of any one of the “independent”, “server-assisted”, and “server-driven” types, is realized by using a portable telephone system and a global positioning system (GPS) here.

In FIG. 4, a portable telephone network 2, a Public Switched Telephone Network (PSTN) 4, and the Internet 6 are provided. The portable telephone network 2, the PSTN 4, and the Internet 6 are connected to each other and thus, they are communicable mutually. GPS satellites 8a, 8b, and 8c are placed in orbit around the earth.

A portable telephone terminal 1 according to the first embodiment having a GPS function (i.e., a position-determining function) and an ordinary portable telephone terminal 3 with no position-determining function are connected to the portable telephone network 2 by radio. An ordinary telephone terminal 5 is connected to the PSTN 4. A computer 7 termed a “server” and a computer 10 termed a “OPS server” are connected to the Internet 6. A GPS reference receiver 9 is connected to the GPS server 10.

The portable telephone terminal 1 comprises a GPS receiver section 1a for GPS communication along with a radio communication section 1b for telephone conversation or communication. Therefore, with the terminal 1, not only conversation and data communication can be conducted with the radio communication section 1b but also reception of the information transmitted from the GPS satellites 8a to 8c can be conducted with the GPS receiver section 1a, as the occasion demands.

The GPS reference receiver 9 and the GPS server 10 are mounted in a base station of the portable telephone network 2. The receiver 9 constantly receives the GPS signals to recognize the present position of the base station or the receiver 9 itself.

When the portable telephone terminal 1 is connected to the portable telephone network 2 by radio, the terminal 1 is capable of audio communication or data transmission to the portable telephone terminal 3 connected by radio to the network 2, the telephone terminal 5 connected to the network 2 by way of the PSTN 4, and/or the server 7 connected to the network 2 by way of the Internet 6.

The GPS satellites 8a, 8b, and 8c, which go constantly around the surface of the earth, transmit radio waves including specific GPS information toward the earth. The portable telephone terminal 1 having the GPS function and the GPS reference receiver 9 can receive the radio waves thus transmitted. By receiving the radio waves thus transmitted, the present position of the terminal 1 and the present time thereof can be accurately known, and a clock signal is obtainable as well.

When the position determination method shown in FIG. 1 is of the “independent” type, the terminal 1 receives the radio waves (i.e., the GPS signals) transmitted from the satellites 8a, 9b, and 8c and analyzes the same. All the necessary calculations for finding or determining the current position of the terminal 1 are carried out in the terminal 1 itself based on the GPS information obtained from the waves. As a result, the user of the terminal 1 can know his/her present position at any desired time easily.

When the position determination method shown in FIG. 4 is of the “server-assisted” type, the terminal 1 conducts data transmission or communication with the GPS server 10 by way of the network 2 and the Internet 6 in advance, thereby acquiring the information necessary for position determination from the GPS server 10. The information thus acquired is stored in a storing medium (not shown) mounted in the terminal 1. The terminal 1 receives the radio waves (i.e., the GPS signals) transmitted from the satellites 8a, 9b, and 8c and then, analyzes part of the GPS signals thus received. Thereafter, the terminal 1 conducts all necessary calculations for finding or determining the current position of the terminal 1 using the result of the analysis and the stored information. As a result, the user of the terminal 1 can know his/her present position.

When the position determination method shown in FIG. 4 is of the “server-driven” type, the terminal 1 receives the radio waves (i.e., the GPS signals) transmitted from the satellites 8a, 9b, and 8c and then, analyzes part of the GPS signals thus received. On the other hand, the terminal 1 transmits the GPS signals received to the GPS server 10 by way of the network 2 and the Internet 6. Then, the GPS server 10 conducts the calculations for position determination using the GPS signals thus received. After all the necessary calculations are completed, the server 10 transmits the calculation result (i.e., the position information) to the terminal 1 by way of the Internet 6 and the network 2. As a result, the user of the terminal 1 can know his/her present position.

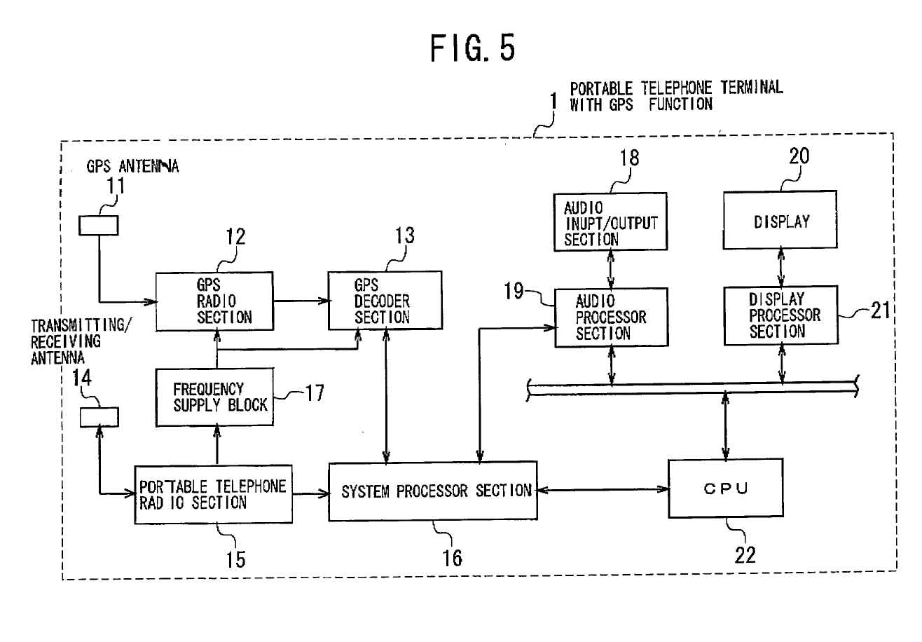

FIG. 5 shows an example of the circuit configuration of the portable telephone terminal 1 with the GPS function used in the method of FIG. 1.

In FIG. 5, a GPS antenna 11 receives the GPS signals sent from the satellites 8a, 8b, and 8c in the form of radio waves. A GPS radio section 12 demodulates the GPS signals thus received by the antenna 11 according to a specific method. AGPS decoder section 13 decodes the GPS signals thus demodulated by the section 12 according to a specific method. A transmitting/receiving antenna 14 transmits or receives a radio signal for portable telephone. A portable telephone radio section 15 modulates the portable telephone radio signal to be transmitted or demodulates the portable telephone radio signal received. A system processor section 16 processes the portable telephone signals to be transmitted or received and the GPS signals received.

A frequency supply block 17 supplies a necessary clock signal or signals to the GPS radio section 12 and the GPS decoder section 13 based on a frequency outputted from the portable telephone radio section 15.

An audio input/output section 18 is used for the user to input his/her voice into the terminal 1 and to output the voice of a person the user communicates with from the terminal 1. An audio processor section 19 processes the audio or voice information that passes through the section 18. A display 20 displays necessary information on the screen (not shown) to notify it to the user. A display processor section 21 processes the information to be displayed on the screen of the display 20. A CPU (Central Processing Unit) 22 controls the whole operation of the terminal 1.

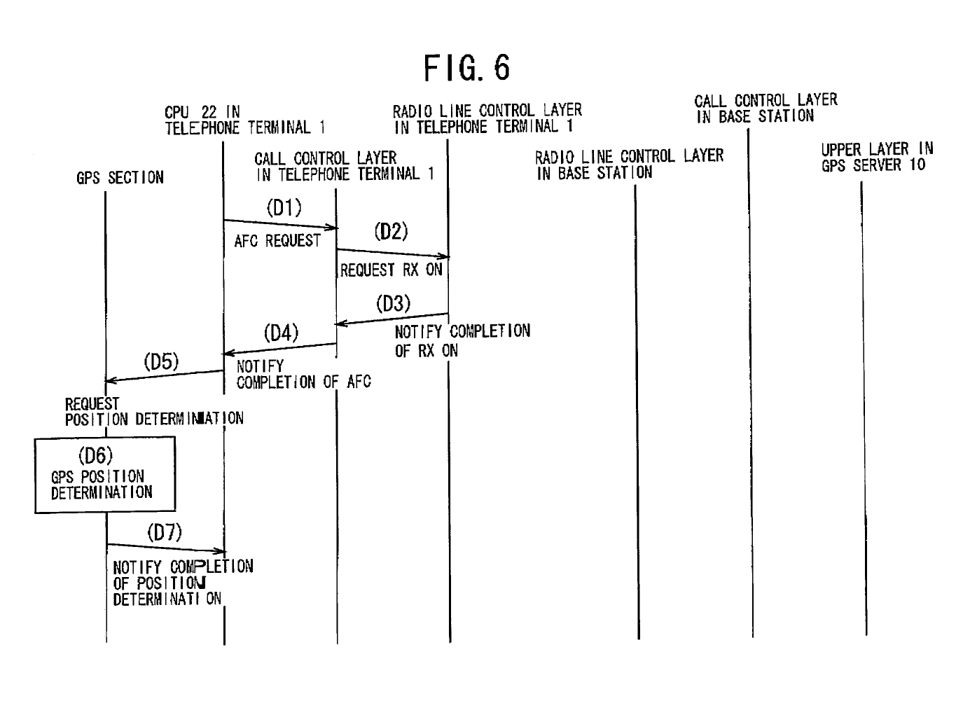

FIG. 6 shows an example of the GPS position determination operation of the “independent” type, which is conducted in the portable telephone terminal 1 of the first embodiment shown in FIGS. 4 and 5. However, this operation may be of the “server-assisted” or “server-driven” type. In this case, it can be conducted in a similar way as the “independent” type.

In FIG. 6, first, the CPU 22 in the terminal 1 makes an AFC (Automatic Frequency Control) request to the call control layer in the terminal 1 (step D1). In response, the said call control layer makes a request (RX ON) of activating the receiver circuit (RX) of the portable telephone radio section 15 to the radio line control layer in the terminal 1 (step D2). Thus, the said radio line control layer activates the receiver circuit (RX) of the section 15. The receiver circuit (RX) thus activated generates a clock signal for the GPS receiver section 1a to be synchronized with that of the portable telephone network 2 and then, sends the clock signal thus generated to the frequency supply block 17. The block 17 supplies the clock signal thus sent to the GPS radio section 12 and the GPS decoder section 13 according to the necessity.

In response to the activation request (step D2) of the receiver circuit (RX), the said radio line control layer in the terminal 1 notifies the completion of activation of the receiver circuit (RX) (step D3) to the said call control layer in the terminal 1. Then, the said call control layer notifies the completion of AFC to the CPU 22 (step D4). At this stage, where the CPU 22 receives the notification of the completion of AFC, preparation for a position determination operation using GPS is finished.

Thereafter, the CPU 22 makes a request for position determination using GPS to the system processor section 16 (step D5). In response to the request, the GPS antenna 11, the GPS radio section 12 and the GPS decoder section 13 cooperate to conduct a specific position determination operation under the control of the section 16 (step D6). Specifically, the GPS radio section 12 receives the GPS signals transmitted from the GPS satellites 8a, 8b, and 8c by way of the antenna 11, and demodulates the same. The GPS decoder section 13 decodes the GPS signals thus demodulated to generate position information about the terminal 1. After the decoding operation of the decoder section 13 is completed, the system processor section 16 notifies the completion of position determination to the CPU 22 (step D7). In this way, the position determination operation of the terminal 1 using GPS is finished.

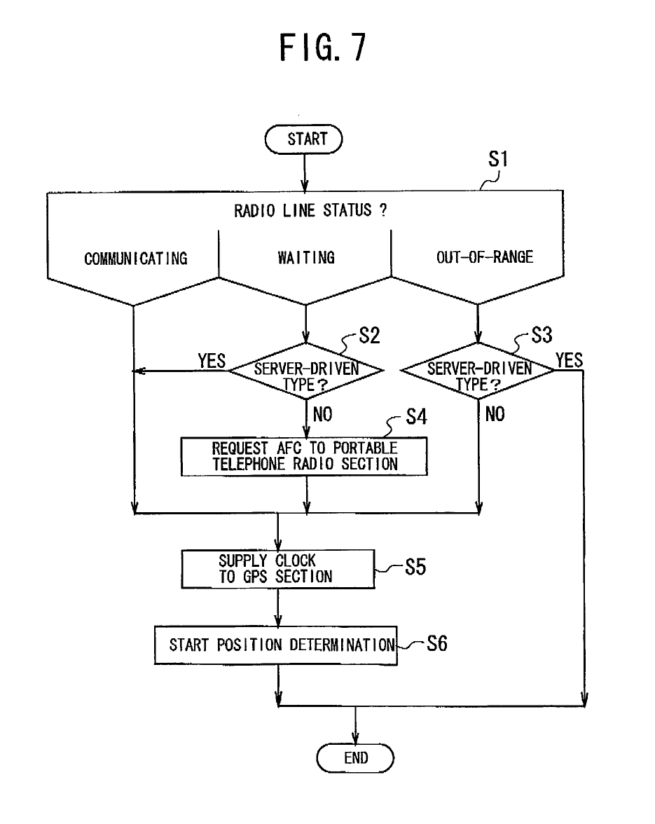

FIG. 7 is a flowchart showing the operation (i.e., communication control) of the portable telephone terminal 1 of the first embodiment.

When conducting the position determination operation, first, the radio line status (i.e., communication status) of the portable telephone radio section 15 of the terminal 1 is examined or checked. In other words, whether the terminal 1 is in the “communicating”, “waiting”, or “out-of-range” state is examined (step S1).

If the terminal 1 is in the “communicating” state in the step $1, the flow is jumped to the step S5. This is because the frequency of the portable telephone radio section 15 has been synchronized with the frequency of the portable telephone network 2. Specifically, since the frequency of the portable telephone radio section 15 has been synchronized with the frequency of the network 2, the frequency supply block 17 receives the clock signal from the radio section 15 and then, supplies the same to the GPS radio section 12 and the GPS decoder section 13 (step S5). Subsequently, the sections 12 and 13 start the position determination operation using GPS (step S6).

If the terminal 1 is in the “waiting” state in the step S1, whether or not the position determination method is of the “server-driven” type is judged (step S2). If the method is of the “server-driven” type, the flow is jumped to the step S5. Therefore, like the case where the terminal 1 is in the “communicating” state, the frequency supply block 17 receives the clock signal from the radio section 15 and then, supplies the same to the GPS radio section 12 and the GPS decoder section 13 (step $5). Subsequently, the sections 12 and 13 start the position determination operation using GPS (step S6). This is due to the following reason.

Specifically, with the method of the “server-driven” type, the position determination operation is carried out after the terminal 1 enters the “communicating” state and therefore, the frequency of the radio section 15 is synchronized with the frequency of the portable telephone network 2 prior to start of the position determination operation. As a result, when the method is of the “server-driven” type, the operation flow in the “waiting” state is the same as that in the “communicating” state.

If the method is not of the “server-driven” type in the step S2, the step S4 is then carried out. In the step S4, an AFC request is sent to the portable telephone radio section 15. In response, the section 15 conducts the AFC operation. After the AFC operation by the section 15 is finished, the section 15 sends a clock signal for GPS section to the frequency supply block 17. The block 17 supplies the clock signal thus received to the GPS radio section 12 and the GPS decoder section 13 (step S5). Subsequently, the sections 12 and 13 start the position determination operation using GPS (step S6).

If the terminal 1 is in the “out-of-range” state in the step S1, like in the step S2, whether or not the position determination method is of the “server-driven” type is judged (step S3). If the method is of the “server-driven” type, the flow is immediately ended without the position determination operation. This is because necessary calculations for the position determination operation are not required in the terminal 1. On the other hand, if the method is not of the “server-driven” type, the flow is jumped to the step S5. Therefore, like the case where the terminal 1 is in the “communicating” state, the frequency supply block 17 receives the clock signal from the radio section 15 and then, supplies the same to the GPS radio section 12 and the GPS decoder section 13 (step S5). Subsequently, the sections 12 and 13 start the position determination operation using GPS (step S6).

With the portable telephone terminal 1 according to the first embodiment shown in FIGS. 4 to 7, as explained above, when conducting the position determination operation, first, the radio line status (i.e., communication status) of the portable telephone radio section 15 is examined or checked. Thus, whether the terminal 1 is in the “communicating”, “waiting”, or “out-of-range” state is discriminated (step S1). Then, if (i) the terminal 1 is in the “communicating” state, (ii) the terminal 1 is in the “waiting” state and does not use the “server-driven” type position determination method, and (iii) the terminal 1 is in the “out-of-range” state and does not use the “server-driven” type position determination method, the frequency supply block 17 supplies the clock signal for the GPS section (which has been derived from the portable telephone radio section 15) to the GPS radio section 12 and the GPS decoder section 13. Subsequently, the sections 12 and 13 start the position determination operation using the GPS signals.

If (iv) the terminal 1 is in the “waiting” state and uses the “server-driven” type position determination method, an AFC request is sent to the portable telephone radio section 15 and then, the section 15 conducts the AFC operation. After the AFC operation is finished, the section 15 sends a clock signal for GPS section to the frequency supply block 17. The block 17 supplies the clock signal thus received to the GPS radio section 12 and the GPS decoder section 13. Subsequently, the sections 12 and 13 start the position determination operation.

If (v) the terminal 1 is in the “out-of-range” state and uses the “server-driven” type position determination method, no position determination operation is carried out using the GPS signals.

Accordingly, when the terminal 1 does not use the “server-driven” type position determination method, in other words, when the terminal 1 uses the “independent” or “server-assisted” type position determination method, a high-accuracy clock signal can be supplied to the GPS radio section 12 and the GPS decoder section 13 for the position determination operation. Thus, a high-accuracy clock signal is supplied to the sections 12 and 13 (i.e., the GPS section) without using an oscillator generating a high-accuracy frequency or the like.

The synchronization of the clock signal for the GPS radio section 12 and the GPS decoder section 13 with that of the portable telephone radio section 15 is carried out prior to the start of the position determination operation. Therefore, the synchronized introduction of the clock signal for the GPS sections 12 and 13 into the terminal 1 can be conducted at an appropriate time or timing. This leads to reduction of the fabrication cost of the terminal 1 itself.

Moreover, according to the radio line or communication status of the portable telephone radio section 15 (in other words, according to whether the terminal 1 is in the “communicating”, “waiting”, or “out-of-range” state), the processes to be conducted before the start of the position determination operation are different from each other. Therefore, the position determination failure and the position determination with insufficient accuracy are prevented effectively. As a result, an optimized frequency circumstance is always obtainable and the sensitivity and speed of position determination are improved.

Further, a phenomenon that electric power is undesirably consumed due to a useless operation for position determination is prevented. Thus, the lifetime of a battery mounted on the portable telephone terminal 1 is prevented from being reduced.

### Second Embodiment

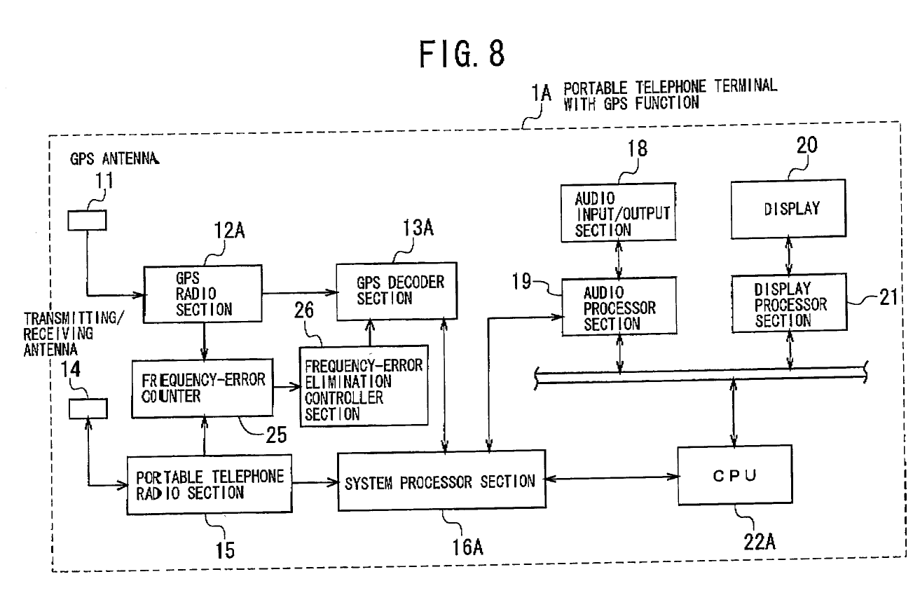

FIG. 8 shows an example of the circuit configuration of a portable telephone terminal 1A with a GPS function according to a second embodiment of the invention.

The terminal 1A of the second embodiment is obtained by replacing the frequency supply block 17 of the terminal 1 according to the first embodiment with the combination of a frequency-error counter 25 and a-frequency-error elimination controller section 26. The other configuration of the terminal 1A is substantially the same as that of the terminal 1. A GPS radio section 12A, a GPS decoder section 13A, a system processor section 16A, and a CPU 22A of the terminal 1A conduct substantially the same operations as those of the GPS radio section 12, the GPS decoder section 13, the system processor section 16, and the CPU 22 of the terminal 1, respectively, except for the differences caused by replacing the block 17 with the combination of the counter 25 and the controller section 26. Accordingly, the detailed explanation about the circuit elements are omitted here by attaching the same reference symbols in FIG. 8.

The frequency-error counter 25 compares the frequency of the GPS radio section 12A with the frequency of the portable telephone radio section 15. Then, the counter 25 counts the difference between these two frequencies and sends the result of count as the “frequency error”.

The frequency-error elimination controller section 26 receives the “frequency error” (i.e., the frequency difference between the sections 12A and 15) from the counter 25. Then, the section 26 changes or adjusts the necessary parameters (e.g., Doppler frequency and pseudo-distance) for decoding operation in the GPS decoder section 13A according to the value or magnitude of the “frequency error”. Thus, the section 26 controls the operation of the GPS decoder section 13A in such a way as to eliminate the “frequency error”. As a result, the decoder section 13A outputs a signal having no frequency error, in other words, the decoded signal by the section 13A is in accordance with a correct frequency.

As seen from the above explanation, the portable telephone terminal 1A of the second embodiment is substantially the same in circuit configuration as the terminal 1 of the first embodiment. The operation of the terminal 1A is the same as the operation of the terminal 1 shown in FIGS. 6 and 7.

Accordingly, with the terminal 1A of the second embodiment, it is obvious that the same advantages as those of the terminal 1 of the first embodiment are obtainable.

### Third Embodiment

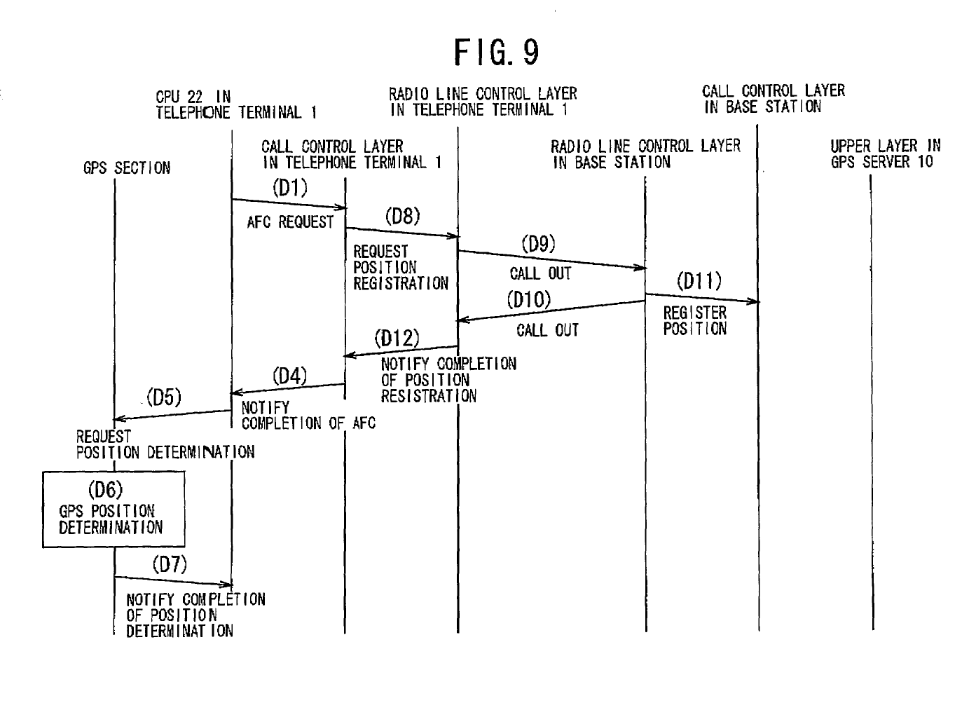

FIG. 9 shows the operation sequence of a portable telephone terminal with the GPS function according to a third embodiment of the invention. Since the terminal of the third embodiment has the same circuit configuration as the terminal 1 of the first embodiment (FIG. 5), the explanation about the configuration is omitted here and the same reference numeral “1” is attached to the terminal of the third embodiment.

In the third embodiment, a “server-assisted” type point determination method is used. However, an “independent” or “server-driven” type point determination method may be used.

In FIG. 9, first, the CPU 22 in the terminal 1 of the third embodiment makes an AFC request to the call control layer in the system processor section 16 (step D1). In response, the said call control layer makes a request for registering the position of the terminal 1 to the radio line control layer in the terminal 1 (step D8). Thus, the said radio line control layer activates the portable telephone radio section 15, thereby making a call out to the radio line control layer in a base station of the portable telephone network 2 (step D9).

In response to the call out from the radio line control layer in the terminal 1, the said radio line control layer in the base station conducts a position registration process to the said call control layer in the same base station (step D11). At the same time, the said radio line control layer in the same base station makes a call out to the said radio line control layer in the terminal 1 (step D10). Thus, the said radio line control layer in the terminal 1 generates a clock signal for the GPS section to be synchronized with the frequency of the portable telephone network 2, and notifies the completion of the position registration to the said call control layer in the terminal 1 (step D12). The frequency thus generated by the said radio line control layer in the terminal 1, which is synchronized with the frequency of the network 2, is sent to the GPS radio section 12 and the GPS decoder section 13 by the frequency supply block 17.

In response to the notification of position registration, the call control layer in the terminal 1 notifies the completion of AFC to the CPU 22 (step D4). At this stage, where the CPU 22 receives the notification of the completion of AFC, preparation for position determination using GPS is finished.

Thereafter, the CPU 22 makes a request of position determination using GPS to the system processor section 16 (step D6). In response to the request, the GPS antenna 11, the GPS radio section 12 and the GPS decoder section 13 cooperate to conduct a specific position determination operation under the control of the section 16 (step D6). Specifically, the GPS radio section 12 receives the GPS signals transmitted from the GPS satellites 8a, 8b, and 8c by way of the antenna 11, and demodulates the same. The GPS decoder section 13 decodes the GPS signals thus demodulated to generate position information about the terminal 1. After the decoding operation of the decoder section 13, the system processor section 16 notifies the completion of position determination to the CPU 22 (step D7). In this way, the operation of position determination of the terminal 1 is finished.

With the portable telephone terminal 1 according to the third embodiment conducting the operation sequence shown in FIG. 9, the circuit configuration is the same as that of the terminal 1 of the first embodiment (FIG. 5) and the operation flow is the same as that of the first embodiment (FIG. 7). Therefore, it is obvious that the same advantages as those of the first embodiment are obtainable.

### Fourth Embodiment

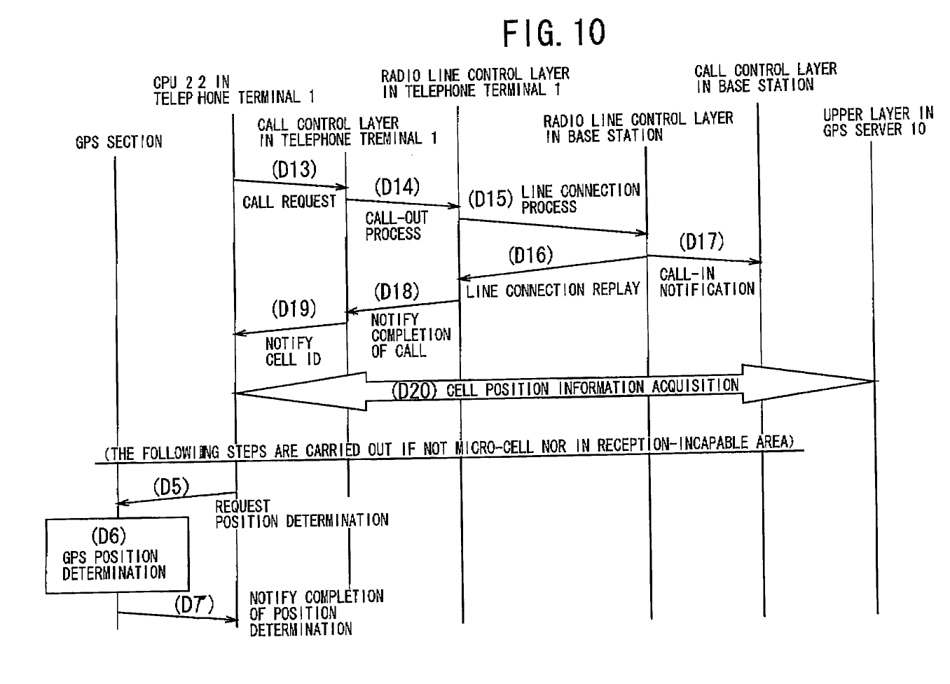

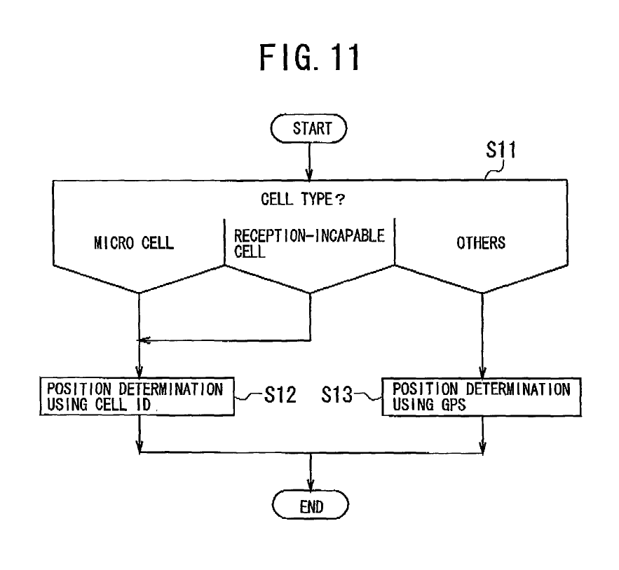

FIG. 10 shows the operation sequence of a portable telephone terminal with the GPS function according to a fourth embodiment of the invention and FIG. 11 shows the operation flow thereof.

Since the portable telephone terminal of the fourth embodiment has the same circuit configuration as the terminal 1 of the first embodiment (FIG. 5), the explanation about the configuration is omitted here and the same reference numeral “1” is attached to the terminal of the fourth embodiment.

In the fourth embodiment, a “server-assisted” type point determination method is used. However, an “independent” or “server-driven” type point determination method may be used.

In FIG. 10, the CPU 22 of the terminal 1 of the fourth embodiment makes a call request to the call control layer in the system processor section 16 of the terminal 1 (step D13). In response, the said call control layer conducts a call-out process to the radio line control layer in the terminal 1 (step D14) Thus, the said radio line control layer activates the portable telephone radio section 15, thereby conducting a line connection process to the radio line control layer in a base station of the portable telephone network 2 (step D15).

In response to the line connection process from the radio line control layer in the terminal 1, the said radio line control layer in the base station notifies a call in to the call control layer in the same base station (step D17). At the same time, the said radio line control layer in the same base station makes a line connection reply to the said radio line control layer in the terminal 1 (step D16). Thus, the said radio line control layer in the terminal 1 generates a clock signal for the GPS section to be synchronized with the frequency of the portable telephone network 2, and notifies the completion of the call-out process to the said call control layer in the terminal 1 (step D18). The frequency thus generated by the said radio line control layer in the terminal 1, which is synchronized with the frequency of the network 2, is sent to the GPS radio section 12 and the GPS decoder section 13 by the frequency supply block 17.

In response to the notification of the completion of the call-out process, the said call control layer in the terminal 1 notifies the CPU 22 the information about the cell ID (identification) of the corresponding base station to which the terminal 1 is being connected (step D19). Thereafter, the CPU 22 conducts a data transfer process with respect to the server 7 by way of the network 2 and the Internet 6, thereby acquiring the cell position information corresponding to the ID of the said base station (step D20).

Subsequently, the CPU 22 conducts the operations according to the flowchart shown in FIG. 11. Specifically, based on the cell ID information of the base station thus acquired from the server 7, the cell type is judged (step S11). In other words, whether the cell is of the “micro cell” type indicating that the cell is a narrow-area cell, of the “reception-incapable cell” indicating that the cell is in a place (e.g., underground or in-house area) where reception of the GPS signal is incapable, or of the “others”.

If the cell is of the “micro cell” or “reception-incapable cell” type in the step S11, a position determination operation is carried out using the cell ID (step S12). Thus, the operation flow is completed. This means that, in these cases, the step D19 is the final step and the subsequent steps D5, D6, and D7 are not carried out.

It the cell is not of the “micro cell” nor “reception-incapable cell” type, in other words, the cell is of the “others” type, in the step S11, a position determination operation is carried out using the GPS signals (step S13). This is because the terminal 1 can receive the GPS signals from the satellites 8a, 8b, and 8c. In this case, thereafter, the CPU 22 makes a request of position determination using GPS to the system processor section 16 (step D5). In response to the request, the GPS antenna 11, the GPS radio section 12 and the GPS decoder section 13 cooperate to conduct a specific position determination operation under the control of the section 16 (step D6). Specifically, the GPS radio section 12 receives the GPS signals transmitted from the GPS satellites 8a, 8b, and 8c by way of the antenna 11, and demodulates the same. The GPS decoder section 13 decodes the GPS signals thus demodulated to generate position information about the terminal 1. After the position determination operation using the GPS signals is completed, the system processor section 16 notifies the completion of position determination to the CPU 22 (step D7). In this way, the operation of position determination of the terminal 1 is finished.

With the portable telephone terminal 1 according to the fourth embodiment conducting the operation sequence shown in FIG. 10 and the operation flow shown in FIG. 11, when conducting the position determination operation, the CPU 22 receives the cell ID information of the corresponding base station with which the terminal 1 is communicating in the portable telephone network 2, thereby acquiring the position information. Then, the CPU 22 discriminates the cell type using the position information thus acquired. Subsequently, the position determination operation is conducted if the operation can be conducted using the GPS signals. On the other hand, if the position determination operation cannot be conducted using the GPS signals, the operation is ended without conducting the position determination operation.

Accordingly, it is obvious that the same advantages as those of the first embodiment are obtainable in the terminal 1 of the fourth embodiment.

### Fifth Embodiment

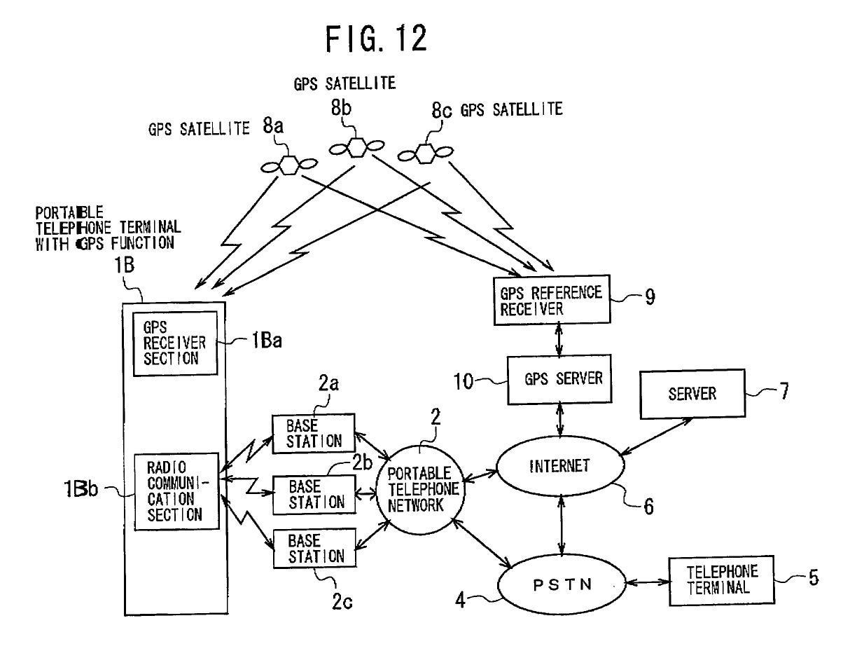

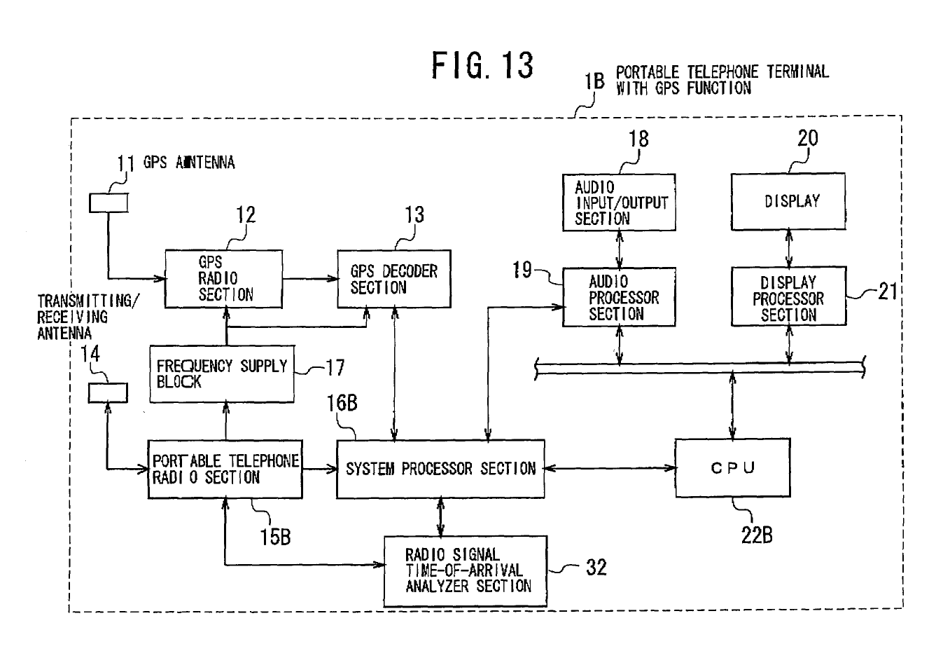

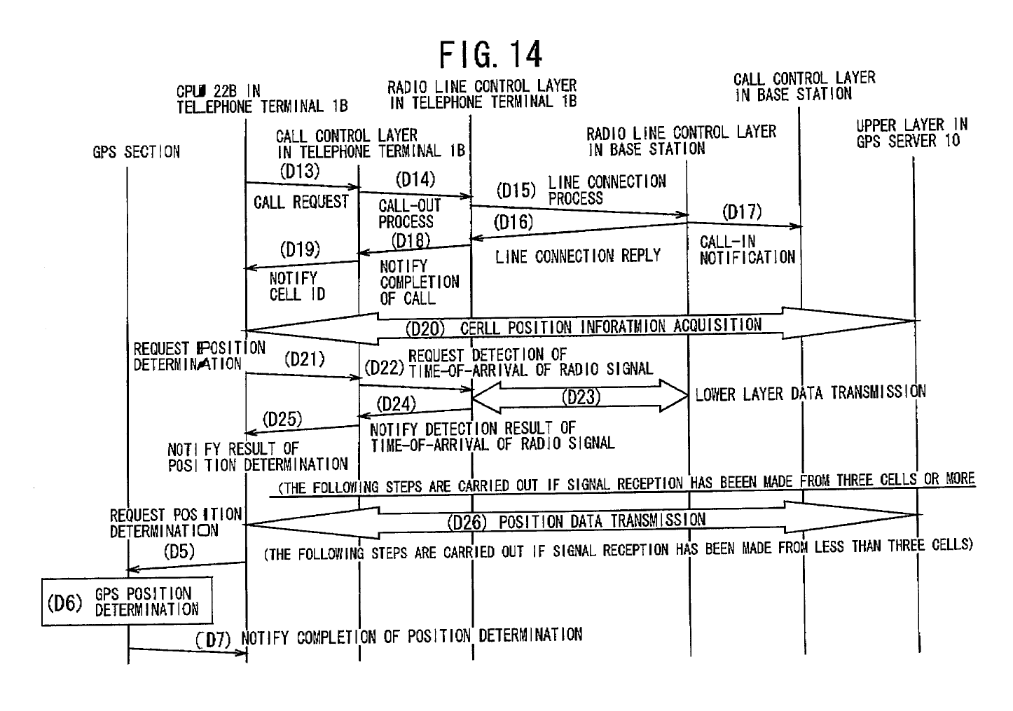

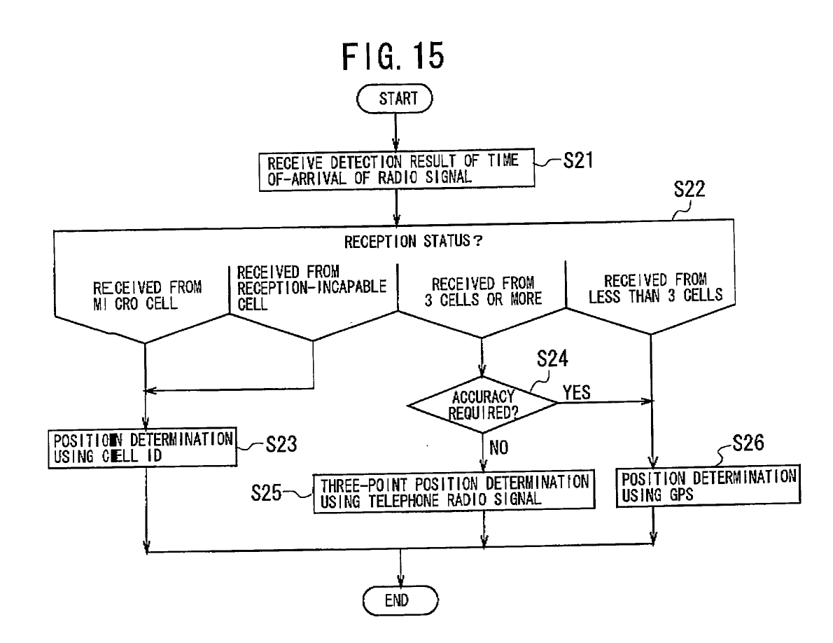

FIG. 13 shows the circuit configuration of a portable telephone terminal 1B having a position-determining function according to a fifth embodiment of the invention. FIG. 12 shows a position determination method using the terminal 1B. FIGS. 14 and 15 show the operation sequence and the operation flow of the terminal 1B, respectively.

In FIG. 12, a portable telephone network 2, a PSTN 4, and the Internet 6 are provided. The network 2, the PSTN 4, and the Internet 6 are connected to each other and thus, they are communicable mutually. GPS satellites 8a, 8b, and 8c are placed in orbit around the earth.

The portable telephone terminal 1B according to the fifth embodiment having a GPS function (i.e., a position-determining function) is connected to the portable telephone network 2 by way of three base stations 2a, 2b, and 2c. In other words, the terminal 1B is simultaneously conducting a transmitting operation and/or a receiving operation with the base stations 2a, 2b, and 2c. An ordinary telephone terminal 5 is connected to the PSTN 4. A computer 7 termed a “server” and a computer 10 termed a “GSP server” are connected to the Internet 6. A GPS reference receiver 9 is connected to the GPS server 10.

The portable telephone terminal 1B comprises a GPS receiver section 1Ba for GPS communication along with a radio receiver section 1Bb for telephone conversation or communication. Therefore, with the terminal 1B, not only conversation and data communication can be conducted with the radio receiver section 1Bb but also reception of the information transmitted from the GPS satellites 8a to 8c can be conducted with the GPS receiver section 1Ba, as the occasion demands.

The GPS reference receiver 9 and the GPS server 10 are mounted in one of the base stations constituting the portable telephone network 2. The receiver 9 constantly receives the GPS signals to recognize the present position of the base station or the receiver 9 itself.

When the portable telephone terminal 1B is connected to the portable telephone network 2 by radio, the terminal 1B is capable of audio communication or data communication to the telephone terminal 5 connected to the network 2 by way of the PSTN 4, and/or the server 7 connected to the network 2 by way of the Internet 6.

The GPS satellites 8a, 8b, and 8c, which go constantly around the surface of the earth, transmit radio waves including specific information toward the earth. The terminal 1B having the GPS function and the GPS reference receiver 9 can receive the radio waves thus transmitted. By receiving the radio waves thus transmitted, the accurate present position of the terminal 1B and the accurate present time thereof can be known, and further, a clock signal can be obtained.

The terminal 1B having the configuration of FIG. 13 is obtained by adding a radio signal time-of-arrival analyzer section 32 to the terminal 1 (FIG. 5) of the first embodiment The other configuration of the terminal 1B is substantially the same as that of the terminal 1. A portable telephone radio section 15B, a system processor section 16B, and a CPU 228 respectively conduct the same operations as those of the portable telephone radio section 15, the system processor section 16, and the CPU 22 in the terminal 1, except for the differences caused by addition of the section 32. Therefore, the explanation of these circuit elements is omitted here by attaching the same reference symbols as the first embodiment.

The radio signal time-of-arrival analyzer section 32 analyzes the time-of-arrival of a telephone radio signal generated by the portable telephone radio section 15B. The result of the analysis is sent to the system processor section 16B. The section 16B controls the operation of the CPU 22B and the GPS decoding section 13.

Next, the operation of the terminal 1B of the fifth embodiment is explained below with reference to FIGS. 14 and 15.

In FIG. 14, the steps D13 to D20 are the same as those shown in FIG. 10 indicating the operation sequence of the terminal 1 of the fourth embodiment. Therefore, the explanation thereof is omitted here.

In the step D20, the CPU 22B acquires the position information corresponding to the cell IDs of the base stations 2a, 2b, and 2c with which the terminal 13 is communicating in the network 2. Then, the CPU 22B makes a request of position determination to the call control layer in the system processor section 1 GB (step D21). In response, the said call control layer makes a request for detection of the time-of-arrival of radio signals to the radio line control layer in the terminal 1B (step D22). Thus, the said radio line control layer conducts a lower layer data transmission with respect to the said radio line control layers in the base stations 2a, 2b, and 2c (step D23). In this way, the radio signal time-of-arrival analyzer section 32 detects the times-of-arrival of the radio signals transmitted from/to the base stations 2a, 2b, and 2c. Then, the section 32 notifies the result of detection of the time-of-arrival to the said call control layer in the system processor section 16B (step D24). The said call control layer notifies the detection result thus received to the CPU 22B (step D25).

At this stage, the operation flow shown in FIG. 15 is carried out. Specifically, the CPU 22B receives the detection result (i.e., the data of the time-of-arrival of the radio signals) from the said call control layer in the system processor section 16B in the step S21. Thereafter, the CPU 22B judges the reception status of the terminal 1B in the step S22.

Specifically, based on the detection result (i.e., the data of the time-of-arrival) of the radio signals from the base stations 2a, 2b, and 2c thus acquired, the reception status is judged by the CPU 22B (step S22). In other words, it, is judged whether the radio signal reception is made from the “micro cell” indicating that the cell is a narrow-area cell, from the “reception-incapable cell” indicating that the cell is in a place (e.g., underground or in-house area) where reception of the GPS signal is incapable, from “three cells (i.e., three base stations) or more, or from “less than three cells”.

If the result of judgment in the step S22 is from the “micro cell” or the “reception-incapable cell”, a position determination operation is carried out using the cell IDs (step S23). Thus, the operation flow is completed. This means that, in these cases, the step D25 is the final step and the subsequent steps D5, D6, and D7 are not carried out.

If the result of judgment in the step S22 is from the “three cells or more”, not from the “micro cell” nor the “reception-incapable cell”, the step S24 is then carried out to judge whether high accuracy is required for position determination (step S24). If high accuracy is not required, the CPU 22B conducts a position determination operation using the radio signals and the so-called “three-point problem” (step S25). The GPS signals from the satellites 8a, 8b, and 8c are not used for this purpose. The position determination data thus obtained are then transmitted by the CPU 22B to the GPS server 10 (step D26). Thus, the operation flow is completed.

On the other hand, if high accuracy is required in the step S824, the flow is jumped to the step S26 and carried out. In the step S26, a position determination operation is carried out using the GPS signals (i.e., the steps D5, D6, and D7 are conducted). Thus, the operation flow is completed.

If the result of judgment in the step S22 is from the “less than three cells”, not from the “micro cell” nor the “reception-incapable cell”, the step S26 is then carried out to conduct a position determination operation using the GPS signals (i.e., the steps D5, D6, and D7 are conducted). This is because the so-called “three-point problem” (step S25) is unable to be used. Thus, the operation flow is completed.

With the portable telephone terminal 1B of the fifth embodiment, as explained above, when conducting a position determination operation, the radio signals transmitted from the cells of the corresponding base stations with which the terminal 1B is communicating are received and then, the time-of-arrival of these signals is analyzed to recognize the reception status of the terminal 1B (i.e., the type and count of the said cells). Thereafter, if a position determination operation using the cell IDs is possible, it is carried out. If a position determination operation using the radio signals from the base stations is possible, it is carried out. If both of these two operations are not possible, a position determination operation using the GPS signals is carried out. Accordingly, the same advantages as those of the first embodiment are obtainable.

Moreover, with the terminal 1B of the fifth embodiment, if the terminal 1B is placed in an undesired circumstance where reflection of radio waves (i.e., radio signals) frequently occurs and/or reception of the GPS signals is incapable or insufficient, the point determination operation is realized by using the cell IDs or the “three-point problem” with the portable telephone radio signals. These two methods will provide higher accuracy than the method using the GPS signals and therefore, there is an additional advantage that obtainable accuracy for point determination is improved. As a result, useless operation for point determination is decreased, which leads to power reduction of the terminal 1B and to time reduction for point determination.

Since the control method for radio communication is changed or adjusted in the terminal 1B according to the frequency of the point determination operation, there is a further additional advantage that the effects to be applied to an application using the GPS function can be minimized.

### Variations

Needless to say, the present invention is not limited to the above-described first to fifth embodiments, because they are preferred examples of the invention. Any change or modification may be added to them within the spirit of the invention.

For example, a point determination method using the GPS is used in the above-described embodiments. However, the invention is not limited to this. Any other a point determination method than that using the GPS may be used if it is capable of point determination using the signals transmitted from satellites.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A portable telephone terminal with a position-determining function, comprising:
a first radio section for transmitting and receiving a telephone signal;
a second radio section for receiving a position determination signal from a satellite; and
a clock synchronizer for synchronizing a clock signal for the second radio section with a clock signal for the first radio section based on a frequency obtained from the first radio section prior to start of a position determination operation.

2. The terminal according to claim 1, further comprising a controller for controlling the operations of the first and second radio sections;
wherein the controller conducts its operation in such a way as to connect the terminal to a radio line prior to an operation for position determination; and
wherein the clock synchronizer conducts its synchronization operation after the terminal is connected to the radio line.

3. The terminal according to claim 1, wherein the controller makes a judgment whether the radio line is in a state of communicating, waiting, or out-of-range, and according to result of the judgment, the position determination operation is conducted in different ways.

4. The terminal according to claim 1, wherein the clock synchronizer comprises a frequency supplier for supplying the frequency obtained from the first radio section to the second radio section.

5. The terminal according to claim 1, wherein the clock synchronizer comprises
a frequency error calculator for calculating a frequency-error by comparing the frequency obtained from the first radio section with a frequency obtained from the second radio section; and
a frequency-error elimination controller for controlling a decoder for position determination in such a way as to eliminate the frequency error.

6. The terminal according to claim 1, wherein the position determination operation of the controller is of an independent type.

7. The terminal according to claim 1, wherein the position determination operation of the controller is of a server-assisted type;
and wherein the portable telephone terminal is connected to the radio line prior to start of a position determination operation, auxiliary data required for calculation for position determination is received from a server by way of a portable telephone network, and thereafter, the position determination operation of the controller is conducted.

8. The terminal according to claim 7, wherein the controller registers a position of the portable telephone terminal in the server by way of the portable telephone network;
and wherein the clock synchronizer conducts its synchronization operation of the clock signal for the second radio section with the clock signal for the first radio section using a frequency corresponding to the position registered.

9. A portable telephone terminal with a position-determining function, comprising:
a first radio section for transmitting and receiving a telephone signal;
a second radio section for receiving a position determination signal from a satellite; and
a controller for controlling operations of the first and second radio sections;
wherein the controller conducts its control operation in such a way as to acquire cell information identifying or specifying a cell to which the portable telephone terminal belongs from outside by way of a portable telephone network;
and wherein if a desired position determination operation can be conducted based on the cell information acquired, the controller conducts its control operation in such a way as to conduct the desired position determination operation using the cell information without using the position determination signal from the satellite.

10. The terminal according to claim 9, wherein if a desired position determination operation cannot be conducted based on the cell information acquired, the controller conducts its control operation in such a way as to conduct the desired position determination operation using the position determination signal from the satellite.

11. The terminal according to claim 9, wherein it a desired position determination operation cannot be conducted based on the cell information acquired, the controller conducts its control operation in such a way as to synchronize a clock signal for the second radio section with a clock signal for the first radio section based on a frequency obtained from the first radio section prior to start of the desired position determination operation using the position determination signal from the satellite.

12. A portable telephone terminal with a position-determining function, comprising:
a first radio section for transmitting and receiving a telephone signal;
a second radio section for receiving a position determination signal from a satellite;
an analyzer for analyzing times of arrival of telephone signals obtained from the first radio section; and
a controller for controlling operations of the first and second radio sections;
wherein the analyzer analyzes times of arrival of the telephone signals obtained from the first radio section, thereby calculating their time differences of arrival;
and wherein the controller conducts its control operation in such a way as to conduct a position determination operation based on the time differences of arrival calculated.

13. The terminal according to claim 12, wherein if the position determination operation using the time differences of arrival of the telephone signals can be conducted, the controller conducts its control operation in such a way that a position determination operation using the position determination signal from the satellite is not conducted;
and wherein the controller conducts its control operation in such a way that a position determination using the position determination signal from the satellite is conducted if the position determination operation using the time differences of arrival is failed.

14. The terminal according to claim 12, wherein the position determination operation of the controller using the time differences of arrival is of an independent type.

15. The terminal according to claim 12, wherein the position determination operation of the controller using the time differences of arrival is of a server-assisted type;
and wherein the portable telephone terminal is connected to a radio line prior to start of the position determination operation using the time differences of arrival, the terminal receives auxiliary data required for calculation for position determination from a server by way of a potable telephone network, and thereafter, the position determination operation using the time differences of arrival is conducted.

16. The terminal according to claim 12, wherein the position determination operation of the controller using the time differences of arrival is of a server-driven type;
and wherein the portable telephone terminal is connected to a radio line prior to start of the position determination operation using the time differences of arrival, the terminal receives auxiliary data required for calculation for position determination from a server by way of a portable telephone network, and thereafter, calculations necessary for the position determination are conducted in the server.

17. The terminal according to claim 12, wherein if the position determination operation of the controller using the time differences of arrival can be conducted, the controller conducts its control operation in such a way as that necessary calculations for the position determination are conducted in the server.

18. The terminal according to claim 12, wherein the controller conducts its control operation in such a way as to synchronize a clock signal for the second radio section with a clock signal for the first radio section based on a frequency obtained from the first radio section prior to start of a desired position determination operation using the position determination signal from the satellite.

19. The terminal according to claim 12, wherein the controller conducts its control operation in such a way as to conduct a position determination operation using the position determination signal from the satellite after a position determination operation using the time differences of arrival is completed.
